(19) United States
(12) Patent Application Publication
(10) Pub. No.: US 2007/0056817 A1
(43) Pub. Date: Mar. 15, 2007

(54) Damper

(76) Inventor: Michael Ward, Brampton (CA)

Correspondence Address: BERESKIN AND PARR, 40 KING STREET WEST, BOX 401, TORONTO, ON, M5H 3Y2, CA

(21) Appl. No.: 11/221,850

(22) Filed: Sep. 9, 2005

(51) Int. Cl. F16F 9/00

(52) U.S. Cl. 188/314; 188/316

(57) ABSTRACT

A damper is provided. The damper comprises an inner housing, an outer housing, a damping piston assembly and a volume compensation piston. The inner housing defines an inner chamber for holding working fluid. At least a portion of the outer housing is spaced from the inner housing and wherein an outer chamber is defined inside the outer housing and outside the inner housing. The damping piston assembly is longitudinally movable in the inner chamber. Movement of the damping piston assembly changes the available volume of the inner chamber. The volume compensation piston is positioned in the outer chamber and separates the outer chamber fluidically into a first outer chamber portion and a second outer chamber portion. The volume compensation piston is movable in the outer chamber in response to differential pressure between a working fluid in the first outer chamber portion and a compressible volume compensation fluid in the second outer chamber portion.

### FIELD OF THE INVENTION

The present invention relates to dampers, and more particularly to dampers that incorporate a working fluid and a volume compensation fluid that are kept separate.

### BACKGROUND OF THE INVENTION

Shock absorbers, or dampers as they are sometimes called, are used in many applications, including in suspension systems for vehicles of all types. More recently, dampers that include a magnetorheological fluid have been introduced into very limited numbers and types of vehicles, the principal reason for their limited use being the relatively high cost of the fluid itself. These dampers are sometimes referred to as MR dampers.

MR dampers present many advantages over standard dampers as a result of their ability to control and adjust the viscosity of the working fluid very quickly and relatively simply. Typical MR dampers, however, have a relatively long collapsed length, which consumes valuable space in the vehicle and ultimately limits the amount of available suspension travel that the vehicle can have. This can be of particular importance in certain types of vehicles, such as armoured personnel carriers or other military transport vehicles, where the amount of suspension travel is a key concern. MR or similar dampers can potentially be of great use, however, on such vehicles to assist them to travel stably at relatively high speeds, on roads or terrain with uneven and broken surfaces, while bearing relatively high loads as a result of one or more of their payload, their armour and their generally robust construction.

In such vehicles, the amount of available suspension travel is of particular importance and as a result it is desirable to provide a damper, and in particular an MR or similar damper, with a reduced collapsed length, so as permit a greater stroke for a given space available in the vehicle for the damper.

### SUMMARY OF THE INVENTION

In a first aspect, the invention is directed to a damper comprising an inner housing, an outer housing, a damping piston assembly and a volume compensation piston. The inner housing defines an inner chamber for holding working fluid. At least a portion of the outer housing is spaced from the inner housing and wherein an outer chamber is defined inside the outer housing and outside the inner housing. The damping piston assembly is longitudinally movable in the inner chamber. Movement of the damping piston assembly changes the available volume of the inner chamber. The volume compensation piston is positioned in the outer chamber and separates the outer chamber fluidically into a first outer chamber portion and a second outer chamber portion. The volume compensation piston is movable in the outer chamber in response to differential pressure between a working fluid in the first outer chamber portion and a compressible volume compensation fluid in the second outer chamber portion.

### BRIEF DESCRIPTION OF THE DRAWINGS

The present invention will now be described by way of example only, with reference to the attached drawings in which:

FIG. 1 is a sectional side view of a damper 10 in accordance with a first embodiment of the present invention, shown in a collapsed position;

FIG. 2 is a sectional side view of the damper shown in FIG. 1, in an extended position;

FIG. 3 is a magnified sectional side view of a portion of the damper shown in FIG. 1; and

FIG. 4 is a magnified sectional side view of another portion of the damper shown in FIG. 1.

### DETAILED DESCRIPTION OF THE INVENTION

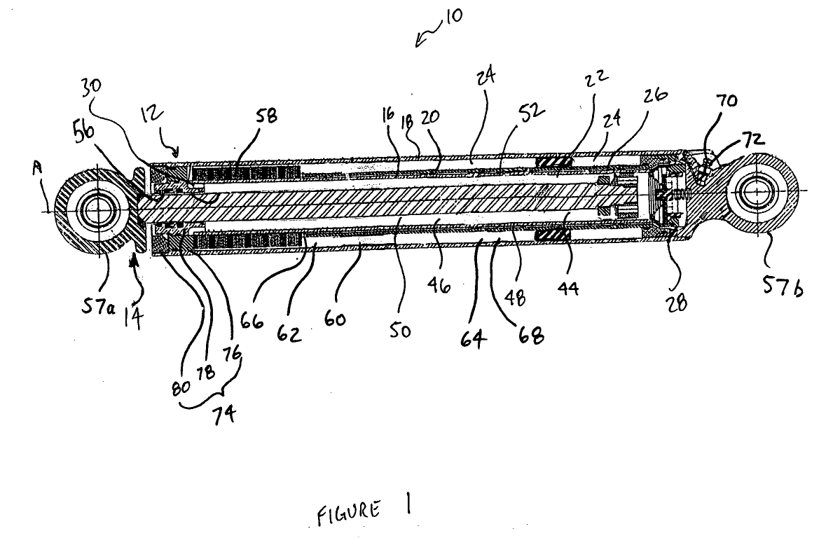

Reference is made to FIG. 1, which shows a damper 10 in accordance with a first embodiment of the present invention. The damper 10 may be used in a vehicle, such as a car, an ATV (all-terrain vehicle) or a military defense vehicle, such as an armoured personnel carrier.

The damper 10 includes a housing assembly 12 and a damping piston assembly 14. The housing assembly 12 includes an inner housing 16, an outer housing 18, and, optionally, an intermediate housing 20, all of which extend longitudinally about an axis A. The inner housing 16 defines an inner chamber 22. An outer, hollow cylindrical chamber 24 is defined between the outer housing 18 and the intermediate housing 20 in embodiments where the intermediate housing 20 is provided. An intermediate chamber 26 is defined between the intermediate housing 20 and the inner housing 16 in embodiments where the intermediate housing 20 is provided.

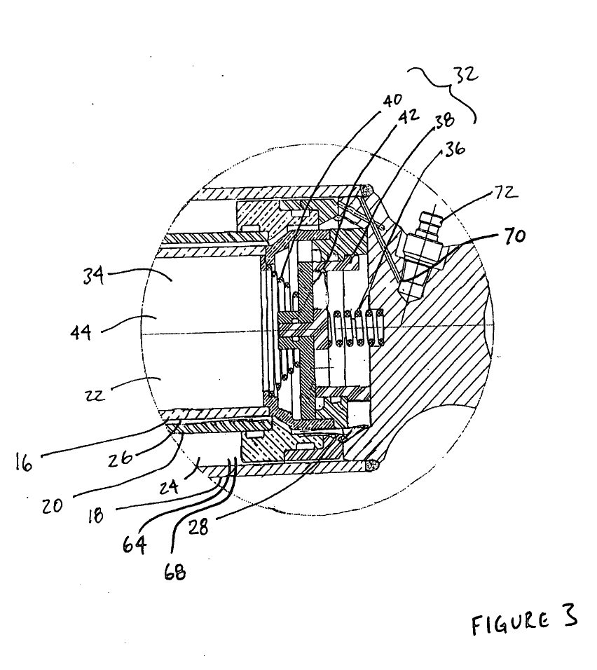

The inner chamber 22 is fluidically connected through a first port 28 to the intermediate chamber 26, and is fluidically connected through a second port 30 to the outer chamber 24. An inner chamber pressure-relief valve 32 opens at a first selected pressure differential to permit a flow of working fluid 34 out from the inner chamber through the first port 28 into the intermediate chamber 26. Referring to FIG. 3, the inner chamber pressure-relief valve 32 includes a first biasing means 36, such as a compression spring, which is connected to a first movable flow control element 38, and which biases the first flow control element 38 towards a closed position. The biasing force of the first biasing means 36 is related to the first selected pressure differential required to open the inner chamber pressure-relief valve 32 to permit outflow of working fluid 34 from the inner chamber 22 through the first port 28.

The inner chamber pressure-relief valve 32 opens at a second selected pressure differential to permit flow out from the intermediate chamber 26 through the first port 28 into the inner chamber 22. The inner chamber pressure-relief valve 32 includes a second biasing means 40, which may be a compression spring. The second biasing means 40 is connected to a second movable flow control element 42 and biases the second flow control element 42 towards a closed position. The biasing force of the second biasing means 40 is related to the second selected pressure differential required to open the inner chamber pressure-relief valve 32 to permit inflow of working fluid 34 into the inner chamber 22 through the first port 28. The first and second selected pressure differentials are described further below.

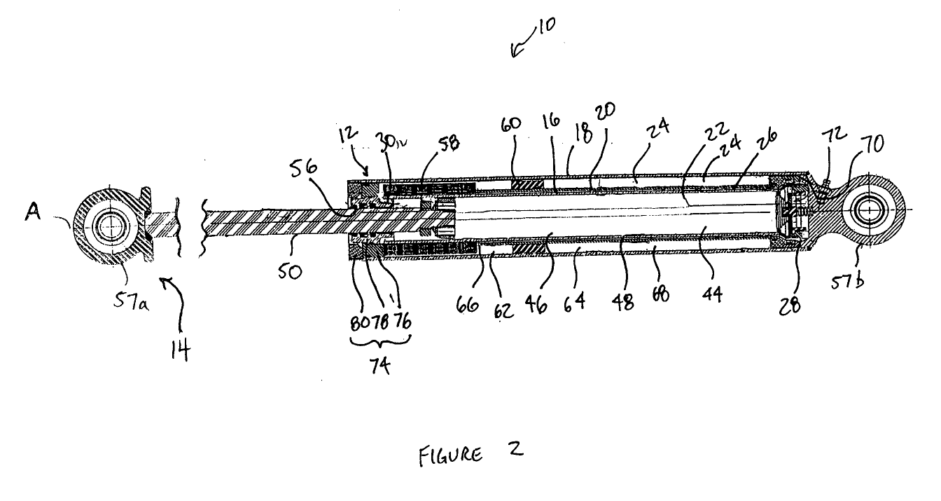

Referring to FIGS. 1 and 2, the damping piston assembly 14 moves longitudinally in the inner chamber 22 and cooperates with the inner housing 16 to separate the inner chamber 22 into a first inner chamber portion 44 and a second inner chamber portion 46. The damping piston assembly 14 includes a piston head 48 and a piston rod 50. The piston head 48 is slidable within the inner housing 16 and forms a seal therewith to prevent a flow of working fluid 34 from passing past the seal.

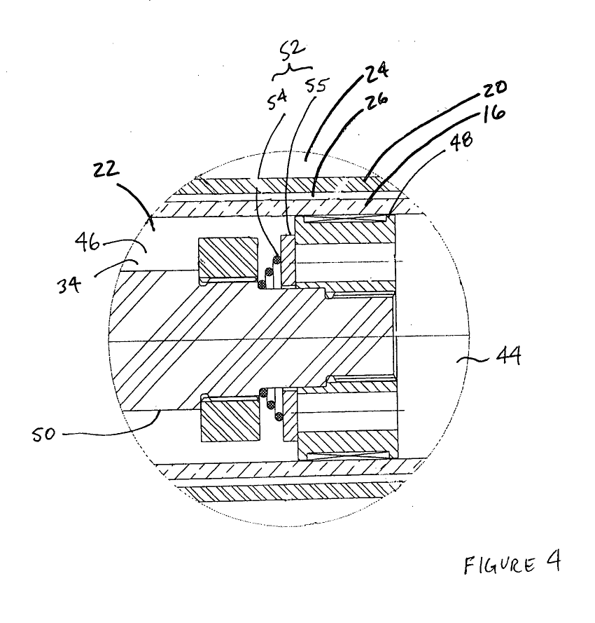

A piston pass-through valve 52 is positioned in the piston head 48 to permit and control the flow of working fluid from the first inner chamber portion 44 into the second inner chamber portion 46, based on a selected pressure differential across the piston head 48. Referring to FIG. 4, the piston pass-through valve 52 includes a biasing means 54, which may be a compression spring, which is connected to a movable flow control element 55, and which biases the flow control element 55 into a closed position. The biasing force of the biasing means is related to the selected pressure differential across the piston head 48 required to open the piston pass-through valve 52.

Referring to FIGS. 1 and 2, once past the piston head 48 and into the second inner chamber portion 46, the working fluid 34 can move between the inner and outer chambers 22 and 24 through the second port 30.

The piston rod 50 is connected to the piston head 48 and extends through the second inner chamber portion 46 and out through an aperture 56 in an end of the housing assembly 12. Suitable seal means are provided which permit sliding engagement of the piston rod 50 against the wall of the aperture 56 while preventing leakage of working fluid 34.

A first connector 57a is provided at the free end of the piston rod 50, for connecting the free end to a suitable vehicle component. A second connector 57b is provided at an end of the outer housing 18 for mounting the housing assembly 12 to another suitable vehicle component.

In embodiments wherein the working fluid 34 is a magnetorheological or similar fluid, a field coil 58, which conducts an electrical current, may be provided to control the viscosity of the working fluid 34. The field coil 58 may be positioned about the inner housing 16. In the embodiment shown in FIG. 1, the field coil 58 is positioned proximate the second port 30 and in part defines a portion of the outer chamber 24, such that a hollow cylindrical volume of working fluid of a selected radial thickness surrounds the outer periphery of the field coil 58. The radial thickness of the volume of working fluid 34 surrounding the field coil 58 is selected to permit a selected efficacy of the field coil 58 when the field coil 58 acts on the working fluid 34 to control the viscosity thereof.

A volume compensation piston 60 slides within the outer chamber 24 and fluidically separates the outer chamber 24 into a first outer chamber portion 62 and a second outer chamber portion 64. The second port 30 fluidically connects the first outer chamber portion 62 with the inner chamber 22. A third port 66 fluidically connects the first outer chamber portion 62 with the intermediate chamber 26. The working fluid 34 thus occupies the first outer chamber portion 62 in addition to occupying the inner chamber on both sides of the piston head 48, and the intermediate chamber 24.

A volume compensation fluid 68 is provided in the second outer chamber portion 64. The volume compensation fluid 68 may be any compressible fluid, such as Nitrogen or another suitable gas. The volume compensation piston 60 moves longitudinally in the outer chamber 24 in response to a pressure differential thereacross between the pressure of the working fluid 34 and the pressure of the volume compensation fluid 68.

The volume compensation piston 60 prevents contact between the working fluid 34 and the volume compensation gas 68. For some working fluids, such as a magnetorheological fluid, contact with air or other gases can detrimental to the performance or longevity of the working fluid. The volume compensation piston 60 prevents such contact while permitting the volume of the first outer chamber portion 64 to be adjusted as necessary during operation of the damper.

A volume compensation fluid inlet port 70 is provided in the outer chamber 24, and fluidically connects to the second outer chamber portion 64. The volume compensation fluid inlet port 70 may be closed with a removable plug 72. This permits the easy emptying and recharging of the second outer chamber portion 64 with volume compensation gas 68.

To charge the damper 10 with working fluid 34 (and to empty the housing assembly of working fluid 34), the housing assembly 12 may be provided with a removable end cap assembly 74. The end cap assembly 74 may itself be made up of several components, such as an outer sealing cap 76, for sealing against the outer housing 18, an inner sealing cap 78 for sealing between the outer sealing cap 76 and the piston rod 50, and a retainer 80, which engages the outer housing 18 by means of a threaded connection and which retains the outer and inner sealing caps 76 and 78 in position. In the embodiment shown in FIGG. 1 and 2, the aperture 56 for the pass-through of the piston rod 50 is defined in the inner sealing cap 78.

As the piston assembly moves between the collapsed position shown in FIG. 1 and the extended position shown in FIG. 2, the overall capacity of the inner chamber 22 for holding working fluid varies with the varying amount of volume that is consumed by the piston rod 50. Movement of the piston assembly 14 inwards, (ie. towards the collapsed position shown in FIG. 1), causes an increase in the amount of volume of the inner chamber 22 that is consumed by the piston rod 50, which, in turn, causes the pressure in the working fluid 34 to rise. The rise in pressure of the working fluid 34 pushes the volume compensation piston 60 against the volume compensation fluid 68 in the second outer chamber portion 64 such that the volume compensation 60 moves to compress the volume compensation fluid 68. This movement of the volume compensation piston 60 effectively decreases the size of the second outer chamber portion 64 and increases the size of the first outer chamber portion 62, so that the overall volume of the damper 10 for holding the working fluid 34 is sufficient in spite of the increasing portion of the volume consumed by the piston rod 50. The movement of the volume compensation piston 60 continues until, eventually, the pressure in the working fluid 34 and the volume compensation fluid 68 equalize, at which point the volume compensation piston 60 stops moving. The amount of volume compensation fluid 68 provided in the second outer chamber portion 64 is selected to provide a selected relationship between the longitudinal position of the piston assembly 14 in the damper 10 and pressure of the working fluid 34.

Also during movement of the piston assembly 14 inwards, the pressure of the working fluid 34 in the first inner chamber portion 44 increases relative to the pressure in the second inner chamber portion 46 and relative to the pressure in the intermediate chamber 24, thereby increasing the pressure differentials across the piston pass-through valve 52 and across the inner chamber pressure-relief valve 32. The pressure differential at which the piston pass-through valve is set to open is selected to be lower than the pressure differential at which the inner chamber pressure-relief valve 32 is set to open. Thus, as the pressure of the working fluid 34 in the first inner chamber portion 44 increases, the piston pass-through valve 52 opens to permit the pass-through of working fluid 34 to the other side of the piston head 48 (ie. into the second inner chamber portion 46). The selected pressure differential at which the piston pass-through valve 52 opens may be set to be relatively low so that, even if the piston assembly 14 moves quickly inwards, the flow of working fluid 34 into the second inner chamber portion 44 occurs sufficiently quickly and freely to reduce the risk of cavitation behind the trailing edge of the piston head 48 during its inward movement.

Under some conditions, the pressure of the working fluid 34 in the first inner chamber portion 44 may continue to increase even after the piston pass-through valve 52 has opened. For example, for a sufficiently heavy vehicle or for a vehicle traveling at a sufficiently high speed, a collision between a vehicle wheel or track with a bump could cause the damper 10 to collapse at a rate whereby the collision with the bump continues to cause the pressure in the working fluid in the first inner chamber portion 44 to increase even though fluid is passing through the valve 52 into the second chamber portion 46. Under these conditions, if the pressure of the working fluid 34 in the first inner chamber portion 44 increases beyond a selected threshold, the pressure differential across the inner chamber pressure-relief valve 32 causes the valve 32 to open thereby permitting flow of the working fluid 34 out from the first inner chamber portion 44 through the first port 28. Thus, at sufficiently high pressure, the working fluid 34 is permitted to flow out from the first inner chamber portion 44 both through the piston head 48 and through the first port 28. This provides protection for the damper 10 and its mounts to the vehicle in embodiments wherein it is vehicle mounted against damage during an encounter between a vehicle wheel or track and a bump.

Once the pressure of the working fluid 34 falls below the first selected pressure differential value for the inner chamber pressure-relief valve 32, the valve 32 closes, and the outflow of working fluid 34 continues through the piston pass-through valve 52. When the collapse of the damper 10 stops as a result of the pressure in the volume compensation fluid 68 equalizing with the pressure of the working fluid 34 in the first outer chamber portion 62, the pressure differential across the piston head 48 is zero and the piston pass-through valve 52 closes.

During movement of the piston assembly 14 out from the housing assembly 12, (ie. towards the extended position shown in FIG. 2), the overall capacity of the inner chamber 22 for holding working fluid 34 increases, which results in an overall drop in working fluid pressure. The pressure reduction of the working fluid 34 causes a pressure differential across the volume compensation piston 60, which causes the volume compensation piston 60 to move to reduce the size of the first outer chamber portion 62 and to increase the size of the second outer chamber portion 64, which accommodates expansion of the volume compensation fluid 68.

The movement of the volume compensation piston 60 continues until, eventually, the pressure in the working fluid 34 and the volume compensation fluid 68 equalize, at which point the volume compensation piston 60 stops moving to reduce the size of the first outer chamber portion 62.

Also during movement of the piston assembly 14 outwards, the pressure of the working fluid 34 in the first inner chamber portion 44 decreases, thereby creating a pressure differential across the valve 32. Note that the piston pass-through valve 52 permits flow through the piston 48 in one direction only, which is from the first inner chamber portion 44 to the second inner chamber portion 46. Thus a pressure differential across the piston pass-through valve 52 does not result in the opening of the valve 52 to permit fluid to enter the first inner chamber portion 44 from the second inner chamber portion 46.

As the pressure differential across the inner chamber pressure-relief valve 32 increases beyond the second selected threshold value for the valve 32, the valve 32 opens to permit flow of working fluid 34 from the intermediate chamber 26 into the inner chamber 22. The second selected pressure differential at which the inner chamber pressure-relief valve 32 opens may be set to be relatively low so that, even if the piston assembly 14 moves quickly outwards, the flow of working fluid 34 into the first inner chamber portion 44 occurs sufficiently quickly and freely to reduce the risk of cavitation behind the trailing edge of the piston head 48 during its outward movement.

When the extension of the damper 10 stops as a result of the pressures of the working fluid 34 and the volume compensation fluid 68 equalizing with each other, the pressure of the working fluid 34 in the first inner chamber portion 44 is equal to the pressure of the working fluid in the intermediate chamber 26, and as a result the valve 32 closes.

By providing the volume compensation piston 60, the collapsed length of the damper 10 is reduced, relative to some monotube configurations where a volume compensation fluid and volume compensation piston are all in-line with the chamber in which the piston assembly slides.

The damper 10 is shown in FIGS. 1-4 as having a three-chamber configuration, having an inner chamber, an outer chamber and an intermediate chamber. It is alternatively possible for a damper in accordance with an embodiment of the present invention to have a twin-tube configuration, and to therefore possess only an inner chamber and an outer chamber and no intermediate chamber. In such an alternative configuration, the damper 10 would not include the intermediate housing 20, nor the inner chamber pressure-relief valve 32 and port 28. The damper 10 would include a piston pass-through valve which would permit the flow of working fluid across the piston head 48 in response to movement of the piston head in both longitudinal directions, instead of being in response to movement in one direction only, as is the case with the embodiment shown in FIGS. 1-4. Additionally, in the absence of the intermediate housing 20, the outer chamber would be defined between the outer housing 18 and the inner housing 16.

It will be noted that the damper 10 may initially be provided by a first supplier in an empty state (ie. without working fluid 34 or volume compensation fluid 68). The empty damper 10 would be sent to one or more subsequent suppliers who would charge the damper with working fluid 34 and volume compensation fluid 68.

The primary function of the volume compensation piston 60 and fluid 68 are to accommodate volume changes that occur as a result of the entrance and withdrawal of the piston rod 50 into and out of the inner chamber 22. However, the volume compensation piston 60 and fluid 68 also accommodate changes in the pressure of the working fluid 34 as a result of temperature increases or decreases. These changes are on a smaller scale than the changes that occur from the movement of the piston assembly 14. Nonetheless, accommodating these pressure and volumetric changes is advantageous.

As will be apparent to persons skilled in the art, various modifications and adaptations of the apparatus described above may be made without departure from the present invention, the scope of which is defined in the appended claims.

1. A damper comprising:
an inner housing, wherein the inner housing defines an inner chamber for holding working fluid;
an outer housing, wherein at least a portion of the outer housing is spaced from the inner housing and wherein an outer chamber is defined inside the outer housing and outside the inner housing;
a damping piston assembly longitudinally movable in the inner chamber, wherein movement of the damping piston assembly changes the available volume of the inner chamber; and
a volume compensation piston positioned in the outer chamber, wherein the volume compensation piston separates the outer chamber fluidically into a first outer chamber portion and a second outer chamber portion and wherein the volume compensation piston is movable in the outer chamber in response to differential pressure between a working fluid in the first outer chamber portion and a compressible volume compensation fluid in the second outer chamber portion.

2. A damper as claimed in claim 1, wherein the working fluid is contained in the inner chamber and in the first outer chamber portion, and wherein the compressible volume compensation fluid is contained in the second outer chamber portion.

3. A damper as claimed in claim 2, wherein the working fluid is a magnetorheological fluid, and wherein the damper further includes a field coil, wherein the field coil is connectable to an electrical source to control the viscosity of the magnetorheological fluid.

4. A damper as claimed in claim 1, further comprising:
an intermediate housing, wherein the intermediate housing is positioned between the outer and inner housings, and wherein the outer chamber is defined between the intermediate housing and the outer housing, and wherein an intermediate chamber is defined between the intermediate housing and the inner housing;
a first port fluidically connecting the inner chamber to the intermediate chamber;
a second port fluidically connecting the inner chamber to the outer chamber; and
a third port fluidically connecting the outer chamber to the intermediate chamber.

5. A damper as claimed in claim 1, wherein the damping piston assembly includes a piston head and a piston rod, wherein the piston head is slidable within the inner chamber and wherein the piston rod is connected to the piston head and extends out of the housing assembly.
